(19) United States
(12) Patent Application Publication
(10) Pub. No.: US 2005/0182671 A1
(43) Pub. Date: Aug. 18, 2005

(54) Rental support system

(75) Inventor: Hideo Miyauchi, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/048,910

(22) Filed: Feb. 3, 2005

(30) Foreign Application Priority Data
Feb. 17, 2004 (JP) 2004-40394
Oct. 18, 2004 (JP) 2004-302883

(51) Int. Cl. G06F 17/60

(52) U.S. Cl. 705/5

(57) ABSTRACT

A rental support system includes a first communication device, a second communication device, and a server. The server is in data communication with the first and second communication devices. The first communication device transmits enrollment information to the server. The enrollment information identifies at least one object for rent and a lending period. Upon receiving the enrollment information, the server stores lending information that is based on the enrollment information in an information database. The second communication device transmits request information to the server to identify the at least one object for rent. Upon receiving the request information, the server searches the information database for lending information corresponding to the request information. When found, the server transmits a lending information list obtained as the result of the search to the second communication device. Upon receiving the lending information, the second communication device announces the lending information list.

### CROSS REFERENCE TO RELATED APPLICATIONS

This application is based upon and claims the benefit of priority of Japanese Patent Application No. 2004-40394, filed on Feb. 17, 2004 and Japanese Patent Application No. 2004-302883, filed on Oct. 18, 2004, the contents of which are each incorporated herein by reference.

### FIELD OF THE INVENTION

The present invention relates to a system for supporting the renting of an article such as a parking stall or an automobile is rented to an individual for a period of time that the proper user does not use it.

### BACKGROUND OF THE INVENTION

A problem often encountered by drivers of automobiles is finding a parking spot. When the destination is a facility with a parking lot, no problem arises. However, a problem does arise when one visits a friend's home that is not provided with a parking space or has an insufficient number of parking spaces. This is often due to the lack of a parking lot in close proximity to a residential block. As a result, the driver may park in an unauthorized area that is close to the friend's home.

Even such a residential block is not physically without a parking space. For example, a parking stall owned (or used) by a neighbor may sometimes be vacant. Especially, when the neighbor commutes to work by car, his/her parking stall is vacant all day long on workdays. However, one cannot park his/her car in another's parking stall without permission. Alternatively, one can park his/her car in a neighbor's vacant parking stall after supplying a detailed explanation to the neighbor with whom he/she is personally acquainted and receives permission. Unfortunately however, such acquaintance does not always exist. Even when such acquaintance exists, one may hesitate ask for parking permission. Furthermore, there is no guarantee that the neighbor will be home when one does attempt to ask for parking permission.

Japanese patent document JP-H4-65791A (JP-2873723B2) discloses one example of a device aimed at effectively utilizing parking lots. This device has been made with the following fact taken into account: a parking lot for lease includes parking spaces for long-term lease and short-term lease. Long-term leases often include monthly leases and short-term leases often include hourly leases for which a fee is paid per hour of parking. However, some parking spaces under long-term lease contracts are only occupied during the daytime, while others are only occupied during the nighttime. Thus, the parking spaces are not effectively utilized. Therefore, the above-mentioned device enables a contractor to input an approximate time at which he/she will next occupy the parking stall. This information is stored in a card reader-writer installed in close proximity to the exit gate of the parking lot. This reveals a period of time for which the particular parking stall can be rented to another driver. Therefore, the parking stall may be rented during that period of time.

However, the technique disclosed above has drawbacks. It is predicated on parking lots that have a plurality of parking stalls and are well managed. These parking lots must be provided with card readers/writers. Such a technique or system would be very difficult to implement at a personal residence.

Furthermore, in utilizing the above-described technique, it is impossible to know whether there is a parking stall vacancy without actually arriving at the parking lot. Therefore, it is possible for one to drive a lengthy distance to a parking lot only to determine that no vacant parking stall exists. In this situation, visitors must find parking spaces by themselves and in reality this often leads to the above-mentioned unauthorized parking.

Another scheme that cannot be effectively managed with the above-mentioned system includes the lending of automobiles. Lending an automobile to a complete stranger is difficult to suppose, but lending an automobile to a close friend or family member frequently occurs. Both the interested parties can consult directly with each other by phone. However, there is no guarantee that when one desires to borrow another's automobile that he/she will successfully contact a prospective lender.

As mentioned above, even though a potential lender and a potential borrower may be present at any given time, a problem exists in that they may not always be able to communicate their intentions and, therefore, lending or borrowing of an object for rent cannot be carried out.

### SUMMARY OF THE INVENTION

It is an object of the present invention to allow objects for rent to be appropriately lent and borrowed to facilitate the effective utilization of the objects for rent.

Therefore, one aspect of the present invention provides a rental support system including a first communication device, a second communication device, and a server. The server is in data communication with the first and second communication devices. The first communication device transmits enrollment information to the server. The enrollment information identifies at least one object for rent and a lending period. Upon receiving the enrollment information, the server stores lending information that is based on the enrollment information in an information database. The second communication device transmits request information to the server to identify the at least one object for rent. Upon receiving the request information, the server searches the information database for lending information corresponding to the request information. When found, the server transmits a lending information list obtained as the result of the search to the second communication device. Upon receiving the lending information, the second communication device announces the lending information list.

Another aspect of the present invention provides a rental support system including a first communication device and a second communication device. The first communication device and a second communication device are in data communication with each other. The first communication device stores lending information including at least an object for rent and a lending period. The second communication device transmits request information to the first communication device. Upon receiving the request information from the second communication device, the first communication device transmits the lending information that corresponds to the request for information and identifies an object or rent to the second communication device. Upon receiving the lending information from the first communication device, the second communication device announces the received lending information.

Yet another aspect of the present invention provides a rental support system including a first communication device and a second communication device. The first communication device and the second communication device are in data communication with each other. The first communication device transmits lending information to the second communication device. The lending information identifies at least an object for rent and a lending period. Upon receiving the lending information from the first communication device, the second communication device announces the lending information.

Other features and advantages of the present invention will be appreciated, as well as methods of operation and the function of the related parts from a study of the following detailed description, appended claims, and drawings, all of which form a part of this application.

### BRIEF DESCRIPTION OF THE DRAWINGS

FIG. 1 is a schematic diagram illustrating a parking stall rental support system according to the present invention;

FIG. 2 is a block diagram illustrating a communication device of the parking stall rental support system of FIG. 1;

FIG. 3 is a table illustrating a parking space list of the parking stall rental support system of FIG. 1;

FIG. 4 is a portion of a sequence diagram illustrating an operation of the parking stall rental support system of FIG. 1;

FIG. 5 is a portion of a sequence diagram illustrating the operation of the parking stall rental support system of FIG. 1;

FIG. 6 is a portion of a sequence diagram illustrating the operation of the parking stall rental support system of FIG. 1;

FIG. 7 is a plan view illustrating a plurality of routes between a parking lot of an apartment block and entranceways of the apartment block;

FIG. 8 is a flowchart illustrating a processing associated with generating and transmitting track data for entry and track data for exit according to the parking stall rental support system of FIG. 1; and

FIG. 9 is a flowchart illustrating a guidance process performed by the parking stall rental support system of FIG. 1.

### DETAILED DESCRIPTION OF THE PREFERRED EMBODIMENTS

First, a general description of a parking stall rental support system in accordance with the principles of the present invention will be provided.

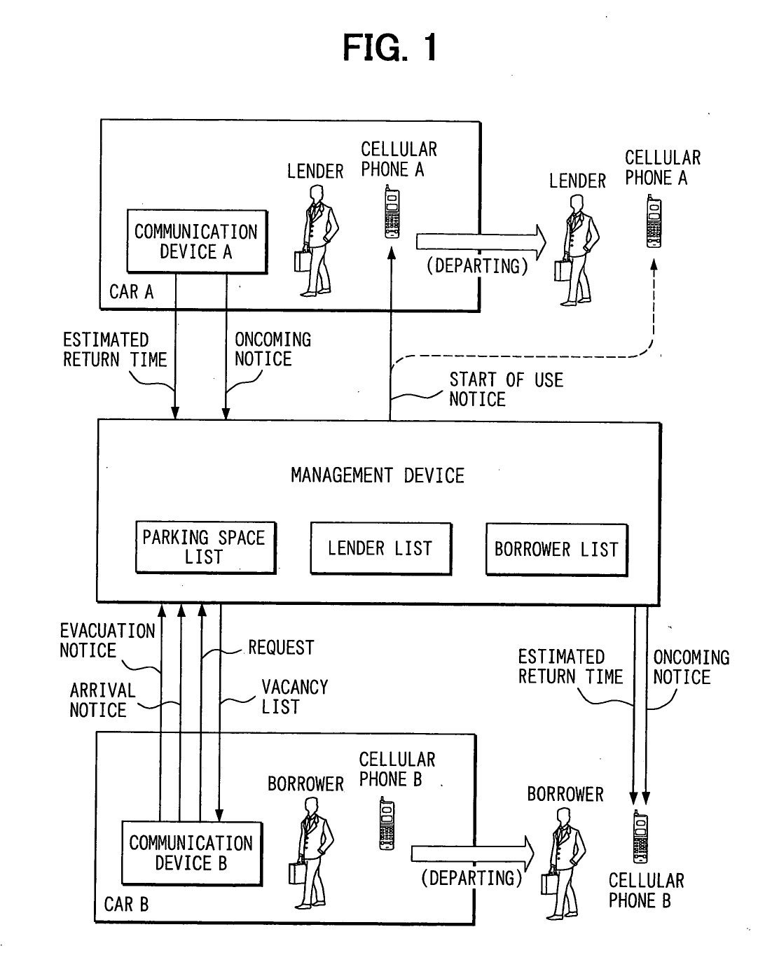

A parking space management device illustrated in FIG. 1 includes a computer connected with a communication network functioning as a server. This parking space management device stores a parking space list, a prospective lender list, a prospective borrower list, and other information. The device receives requests from prospective lenders who desire to lend their parking stalls as objects for rent and informs prospective borrowers who desire to borrow the parking stalls in response to the requests. Thus, the parking space management device supports the lending and borrowing of parking stalls to be smoothly carried out between them.

A plurality of communication devices for the prospective lender includes communication device A mounted on car A and cellular phone A carried by the lender. A plurality of communication devices for the prospective borrower includes communication device B mounted on car B and cellular phone B carried by the prospective borrower. For example, navigation devices provided with communication facilities can be adopted as the communication devices A and B. In this case, the communication devices A and B may themselves be provided with automobile telephone facilities to singly communicate with the parking space management device. Alternatively, the communication devices A and B may be constructed such that when the prospective lender and borrower are in their respective cars A and B, the cellular phones A and B are connected to the respective communication devices A and B. As a result, the communication devices A and B can communicate with the parking space management device. With respect to this embodiment, the following description assumes the latter configuration.

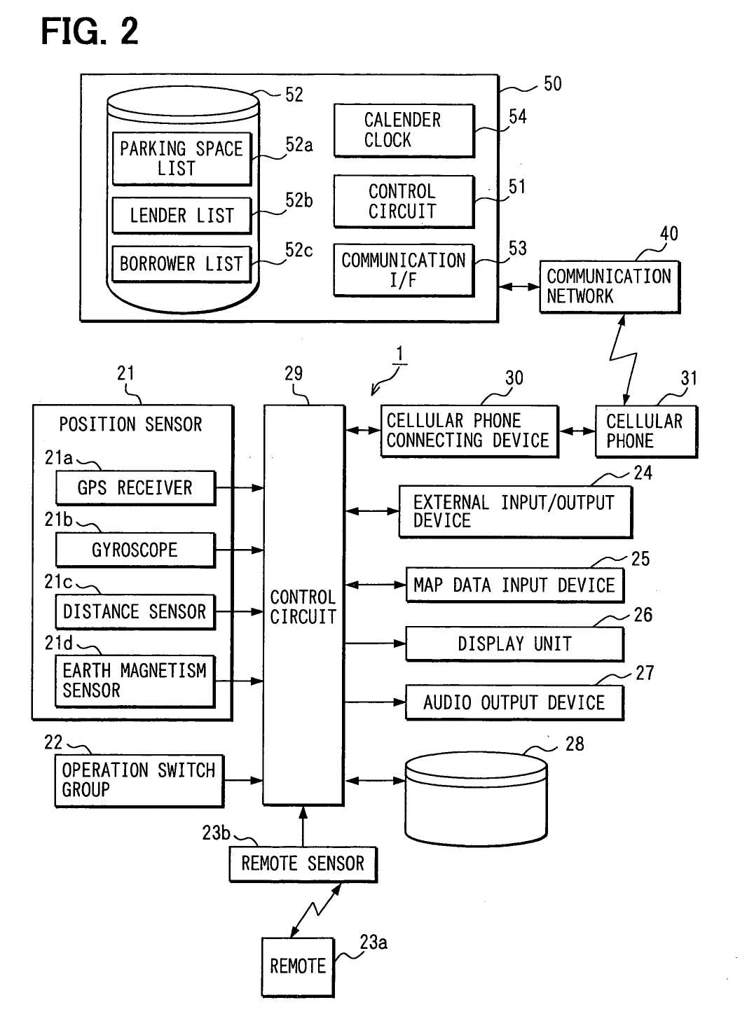

The communication devices A and B are according to the communication device 1 illustrated in FIG. 2. The communication device 1 corresponding to the prospective lender will be hereinafter referred to as communication device A and the communication device 1 corresponding to the prospective borrower will be hereinafter referred to as communication device B, as illustrated in FIG. 1. It should be appreciated however, that when a prospective lender looks for a parking space, he/she becomes a prospective borrower. Therefore, even the same communication device 1 can serve as both a communication device A for the prospective lender or communication device B for the prospective borrower depending on the standpoint of the person carrying the communication device 1. When only at least one lender communication device A and one borrower communication device B exist, a parking stall rental support system is theoretically viable. In reality, however, an appropriate relationship between supply and demand is established when a large number of each exist.

This is the same with the cellular phones A and B. Cellular phone A and cellular phone B are each configured according to the cellular phone 31 illustrated in FIG. 2. The cellular phones 31 corresponding to the prospective lender and the prospective borrower, will be hereinafter referred to as “cellular phone A” and “cellular phone B,” respectively, as illustrated in FIG. 1.

The foregoing is a general description of the parking stall rental support system. The communication device 1 will now be described.

As illustrated in FIG. 2, the communication device 1 mounted on each car includes a position sensor 21 that detects the present position of the car, an operation switch group 22 for inputting various instructions from the user, a remote control terminal (hereinafter, referred to as “remote”) 23a through which various instructions can be inputted as with the operation switch group 22, a remote sensor 23b that inputs signals from the remote 23a, an external information input/output device 24, a map data input device 25 that inputs map data and the like from external recording media on which map data or various information is recorded, a display unit 26 for providing various displays of map display screen, TV screen, and the like, an audio output device 27 for outputting various voice guidance and the like, a hard disk 28 for storing varied data, a cellular phone connecting device 30, and a control circuit 29.

The control circuit 29 executes various processing operations in response to inputs from the above-mentioned position sensor 21, operation switch group 22, remote 23a, external information input/output device 24, map data input device 25, and hard disk 28. In addition, the control circuit 29 controls the position sensor 21, operation switch group 22, remote sensor 23b, external information input/output device 24, map data input device 25, display unit 26, audio output device 27, hard disk 28, and cellular phone connecting device 30.

The position sensor 21 includes a GPS receiver 21a, a gyroscope 21b, a distance sensor 21c, and an earth magnetism sensor 21d. The GPS receiver 21a receives radio waves transmitted from artificial satellites for GPS through a GPS antenna and detects the position, orientation, speed, and the like of the car. The gyroscope 21b detects the magnitude of rotational motion applied to the car. The distance sensor 21c detects the distance traveled from the acceleration of the car in the back and forth direction. The earth magnetism sensor 21d detects the traveling azimuth of the vehicle based on the earth's magnetism. These sensors 21a to 21d have errors different in property. Therefore, the position sensor 21 is configured such that these sensors complement one another. Depending on accuracy, the position sensor 21 may include less than all of the above-mentioned sensors, or additionally, a steering rotation sensor, wheel sensors for the rolling driving wheels, or other sensors found to be appropriate to serve the principles of the present invention.

The operation switch group 22 includes a plurality of mechanical key switches. The key switches are integrated with the display unit 26 and are provided around a touch panel provided above the display screen and the display unit 26. The touch panel and the display unit 26 are stacked and integrated. The touch panel may be one of various types of touch panels including pressure sensitive types, electromagnetic induction types, capacitance types, or any combination thereof. While only a limited number of touch panels have been disclosed, it should be appreciated that any touch panel or similar device serving similar principles is intended to be within the scope of the present invention.

The external information input/output device 24 is for inputting information from various external devices and equipment. For example, the input/output device 24 may be configured to input FM broadcast signals received through a radio antenna (not shown) and radio and optical beacon signals received from fixed stations for VICS (Vehicle Information and Communication System) service installed in proximity to roads. When a PDA (Personal Digital Assistant) is connected, the input/output device 24 is capable of inputting information from that terminal as well.

The map data input device 25 is a device for inputting various data including: road data as network data, map data for map matching for the to increase the accuracy of location identification, mark data indicating facilities, and image and audio data for guidance. As recording media for these data, a CD-ROM, a DVD, a hard disk, a memory, a memory card, or similar device may be implemented.

The display unit 26 is a color display unit including a liquid crystal display, a plasma display, a CRT, or other similar display device operable to serve the principles of the present invention. The display unit 26 displays a position mark indicating the present position of the car detected by the position sensor 21 and map data inputted through the map data input device 25, a guided route to the destination, and additional data such as names, landmarks, and various other facilities of potential interest. In addition, the display unit 26 is also capable of displaying the guides of facilities. The audio output device 27 can output voices reading directions to facilities inputted through the map data input device 25 and various other information acquired through the external information input/output device 24.

The cellular phone connecting device 30 is connected to a cellular phone 31. The cellular phone 31 communicates with the parking space management device 50 through the communication network 40. An automobile telephone may be connected to the control circuit 29 in place of the cellular phone connecting device 30 and the cellular phone 31. However, this embodiment will be described on the assumption that a cellular phone 31 is connected for communication with the outside world, as mentioned above.

The control circuit 29 includes a conventional microcomputer having a CPU, a ROM, a RAM, an I/O, bus lines that connect these members, and other typical components. Based on programs stored in the ROM, the control circuit 29 executes map display processing and route guidance processing. In map display processing, the control circuit 29 computes the present position of the car. The present position is identified by a set of coordinates and traveling direction based on detection signals from the position sensor 21. Then the control circuit 29 displays a map of the vicinity of the present position read through the map data input device 25 and a map of the scope specified through the operation of the operation switch group 22 via the remote 23a. In route guidance processing, the control circuit 29 selects a facility to be the destination in accordance with the operation of the operation switch group 22 and remote 23a. The selection is based on point data stored in the map data input device 25. Then the control circuit 29 automatically performs route computation to determine the optimum route between the present position and the destination to guide the driver through the route. Various techniques such as the Dijkstra method are known for automatically setting the optimum route.

The control circuit 29 connects to a communication network through the cellular phone connecting device 30 and the cellular phone 31 and is thus capable of communicating with the parking space management device 50.

As illustrated in FIG. 2, the parking space management device 50 includes a control circuit 51 that is responsible for the control of the entire parking space management device 50; a database 52; a communication interface (I/F) 53 for communication with the communication network 40 and the like; and a calendar clock 54 for obtaining date and hour information. The database 52 holds a parking space list 52a that is an aggregate of information related to parking spaces for rent, a prospective lender list 52b that is an aggregate of information related to prospective lenders, and a prospective borrower list 52c that is an aggregate of information related to prospective borrowers.

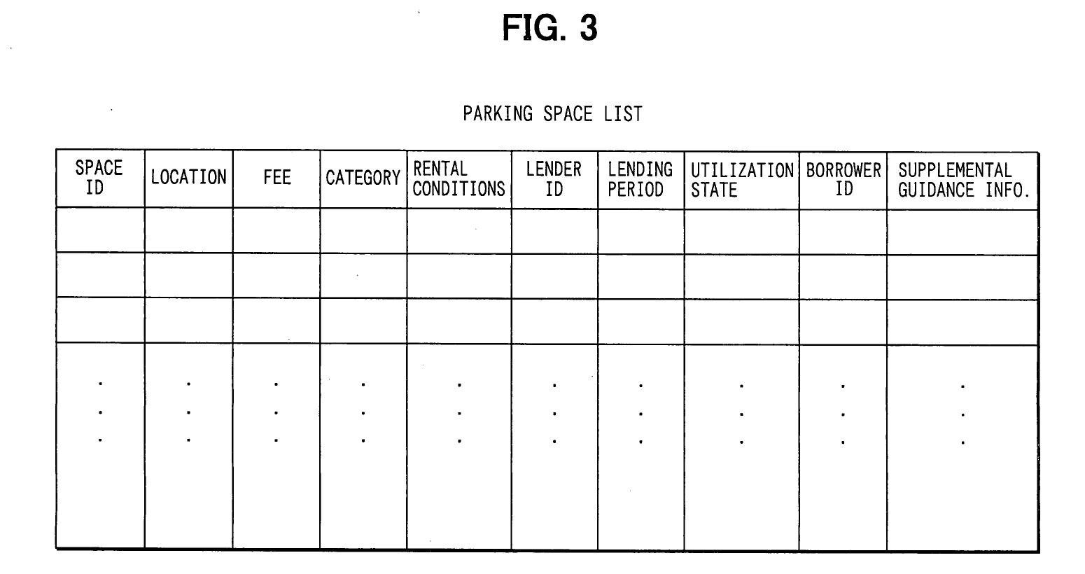

As illustrated in FIG. 3, one embodiment of the parking space list 52a includes identification information (ID), a location, a fee, a category assigned to each parking space, conditions for rental, a prospective lender ID, a lending period, a utilization state, a prospective borrower ID, and supplemental guidance information. Description will be given to these entries in sequence.

The “parking space ID” entry serves only to uniquely identify the parking spaces as objects for rent. Therefore, parking spaces may be provided with serial numbers regardless of their locations or with area codes and serial numbers within designated areas.

For the “location” entry, information similar to a longitude and latitude system can be employed to pin point each parking spot. The information may identify predetermined areas similar to those defined by the navigating system MAPCODE™. For personal residences, the location information may simply include only geographic information such as the latitude and longitude of parking spaces. In case of, for example, collective housing, which has a large number of parking spaces in a parking lot, it is better if the information identifying each parking space is also included in the location information. Even in case of personal residences, the names of prospective lenders can be included in the location information in addition to geographic information such as latitude and longitude. Thus, the prospective borrower can easily find the relevant parking space with the aid of a nameplate or similar signage.

For the “fee” entry, an hourly fee (e.g. $10/hour) can be provided similar to ordinary pay parking lots.

The “category” entry includes information that indicates whether parking spaces as objects for rent are private or general parking. In this embodiment, objects for rent include not only the parking lots of operators who provide them according to a commercial business but also private parking spaces. Therefore, the category information may be useful to distinguish between them. In this case, “private” includes not only parking spaces possessed as immovable properties, but also exclusively held parking spaces, the right of use of which is exclusively held even when they are rented. That is, a “private” parking space is a parking space exclusively held by someone.

The “conditions” entry includes conditions on parking in the parking spaces from a physical viewpoint such as the size of the parking spaces and the types of parking spaces. For example, when a parking space is relatively small and a big car cannot be parked there, the “condition” entry may read “compact car.” When there is any limitation on height, for example, “<=1.5 m” may be provided. Other possible conditions for parking spaces include multilevel car parking tower, whether the parking space is paved or not, or any other imposed condition, physical or not.

The “prospective lender ID” entry includes information for matching the parking spaces with information related to prospective lenders in the prospective lender list 52a. More specifically, the prospective lender list 52b holds the name, address, phone number (at least the phone number of cellular phone A), and account number for settlement for each prospective lender in correlation with the prospective lender ID's. Therefore, when one searches the prospective lender list 52b based on a prospective lender ID in the parking space list 52a, he/she can obtain various information associated with the corresponding prospective lender.

The “lending period” entry includes a period for which a prospective lender is offering to lend his/her parking space for rent. This period is set based on information from the lender's communication device A. The method for settling will be described in detail later.

The “utilization state” entry indicates whether a parking is presently available or not. Specifically, the utilization state can be classified into three categories including “unavailable,” “occupied,” and “vacant.” Unavailable indicates that it is not currently the above-mentioned lending period and the prospective lender does not desire to lend the relevant parking space. Therefore, the parking space cannot be borrowed. Occupied indicates that it is currently the lending period, however, someone else has already borrowed the relevant parking space and, thus, the parking space cannot be presently borrowed. Vacant indicates that it is currently the lending period and the relevant parking space is available for renting. Therefore, the parking space can be presently borrowed.

The “prospective borrower ID” entry includes information for identifying prospective borrowers in the prospective borrower list 52c. More specifically, the prospective borrower list 52c holds the name, address, phone number (at least the phone number of cellular phone B) and account number for settlement, for each prospective borrower in correlation with the prospective borrower ID's. Therefore, when one searches the prospective borrower list 52c based on a prospective borrower ID in the parking space list 52a, he/she can obtain various information associated with the corresponding prospective borrower.

The “supplemental guidance information” entry includes operating methods for equipment and guidance information regarding the vicinity of the parking area such as an apartment block.

The reason why operating methods for equipment are included in the supplemental guidance information is because some parking spaces are not so constructed that drivers can easily park cars. Many require some equipment operation because they are provided with a door or they are multilevel car parking towers. Those who lend parking spaces are familiar with such operating methods for equipment, but those who borrow such a parking space for the first time may not know how to operate the equipment. Therefore, after one goes all the way to a parking space, he/she may become confused. To cope with this, information describing how to operate the equipment is included in the supplemental guidance information. Examples of such data include how to open (and close) a door, how to move down an upper-level parking stall in case one attempts to park his/her car at the upper level of a two-leveled car parking tower, and other such information that may be deemed appropriate.

Guidance information for navigating an apartment block or other parking area includes guidance information specific to parking spaces in company housing, collective housing, or an apartment block. More specifically, the guidance information may include coordinate data indicating the positions of the entrances and exits of the parking area, track data for entry indicating routes connecting entrances to a parking space, track data for exit indicating routes connecting a parking space to exits to public roads, left/right turn data, landmark data, and/or any other desirable data.

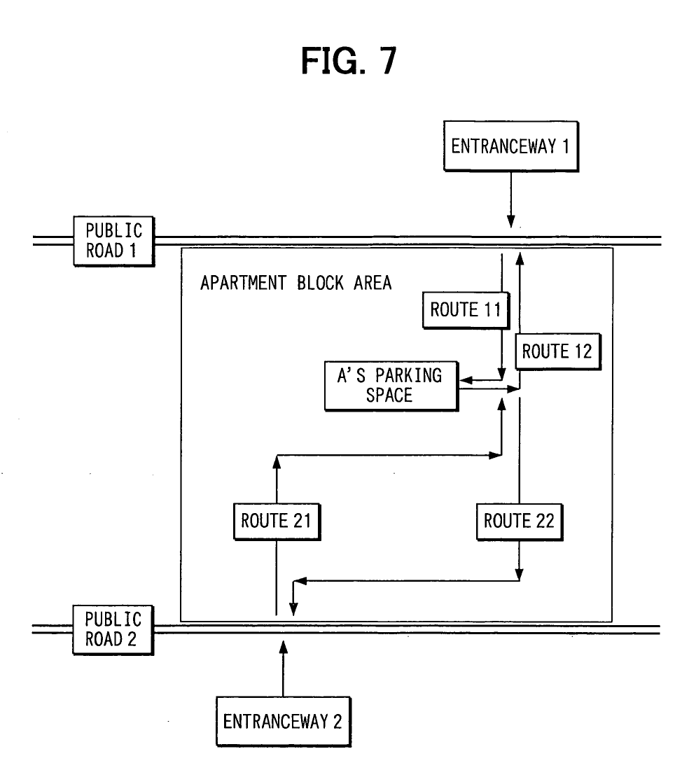

This guidance information is provided because parking spaces are not always parking spaces belonging to detached houses and can be, for example, parking spaces within a large parking lot associated with an apartment block, as illustrated in FIG. 7. In such a case, a borrower may be guided through the parking lot to, for example, a public road based on a map database. However, the roads or traveling paths in the parking lot of the apartment block are not often covered by typical map databases and standard navigation devices do not include these routes because demand for them is relatively small. However, in case of a large-scale parking lot included within the scope of the present invention, the general needs for such maps are relatively great. Thus, traveling routes through the large-scale parking lots can be stored as data in a map database.

For this reason, even when one makes it to a desired apartment block, he/she may yet fail to smoothly arrive at the parking space. For example, there are traffic regulations (e.g. one-way traffic) known only to the inhabitants and the driver may wrongly drive in the opposite direction to traffic. In case of a huge apartment block, entrances may be difficult to find. Even when the driver makes it into the vicinity of the relevant apartment block, he/she can have difficulty in finding an entrance. The guidance information for navigating an apartment block includes information for obviating inconveniences such as having difficulty in finding an entrance to the apartment block and the inconvenience of routes from a public road to a parking space or from a parking space to a public road.

The coordinate data that indicates the positions of the entrances and exits of an apartment block includes points corresponding to entrances from public roads and points corresponding to exits to the public roads. This coordinate data is used when routes connecting the public roads and a parking space are not entered into a map database for use in routing assistance. In addition, track data for entry and track data for exit are adopted. This data is used when routes connecting the public roads and the parking space are not entered into the map database for use in routing assistance. As mentioned above, this data is for coping with cases where an ordinary car navigation device cannot provide routing assistance.

Track data for entry and exit are included because when the driver makes it to an entrance of a desired apartment block, the driver may go into the apartment block through the entrance and easily arrive toward the intended parking space. In other cases however, the apartment block may be huge and routes leading from entrances to the parking space may be complicated. The prospective lender is an inhabitant of the apartment block is familiar with the routes. However, a person who borrows the parking space for the first time may want routing assistance in the apartment block. Referring to track data for entry and track data for exit is useful to the person who borrows the parking space for the first time. In FIG. 7, there are two routes between entranceway 1 from public road 1 to the apartment block area and A's parking space: route 11 as an entry route and route 12 as an exit route. These two routes 11 and 12 are opposite to each other in traveling direction, but use the same traveling path. Meanwhile, there are two routes between entranceway 2 from public road 2 to the apartment block area and A's parking space: route 21 as an entry route and route 22 as an exit route. These two routes use different traveling paths. In other words, routes 21 and 22 include one-way traffic.

The prospective lender who desires to lend his/her parking space as an object for rent can generate this track data for entry and exit. When car A mounted with the communication device A actually runs, this data is generated by communication device A. The data is included in enrollment information and transmitted from communication device A to the parking space management device 50. The data is then included in the guidance information for navigating the apartment block in the parking space list.

The left/right turn and landmark data entries include data for left/right turn assistance useful when the driver drives along the tracks in correspondence with track data for entry and exit. Only either of them may be adopted. Left/right turn and landmark assistance is useful when the driver cannot smoothly drive only with track indication. Such left/right turn and landmark data can be generated by the prospective lender who desires to lend his/her parking space as an object for rent. The landmark such as a billboard may be obtained by the prospective lender taking a photo of the parking space to be used as landmark data.

As mentioned above, the parking space list includes a parking space ID, a location, a fee, a category of parking space, conditions for rental, a prospective lender ID, a lending period, a utilization state, and a prospective borrower ID. Of this information, the following six items are fixed: the parking space ID, the location, the fee, the category of parking space, the conditions for rental, and the prospective lender ID. It should be appreciated that the fee may sometimes be adjusted as the lender sees appropriate. The following three items of information are always dynamic: the lending period, the utilization state, and the prospective borrower ID. The supplemental guidance information is not indispensable and is information that exists only when the prospective lender desires to enroll such supplemental guidance information.

In this embodiment, prospective lenders and parking spaces are entered beforehand into the parking space management device 50. This entry may be made through the communication device A, separately made by the prospective lender by phone, via the Internet, by mail, or any other means of communication. When the parking space list is generated at the parking space management device 50 that accepted such enrollment information, the above six items of fixed information are set. With respect to prospective borrowers, similarly, information to be stored in the above-mentioned prospective borrower list 52c is entered beforehand into the parking space management device 50.

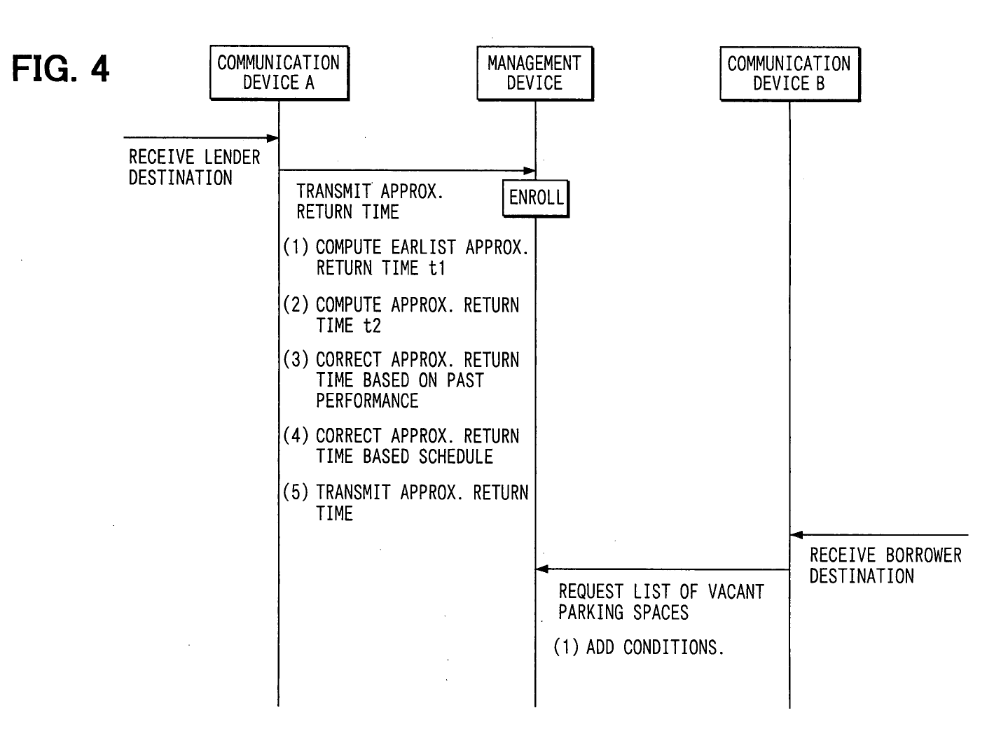

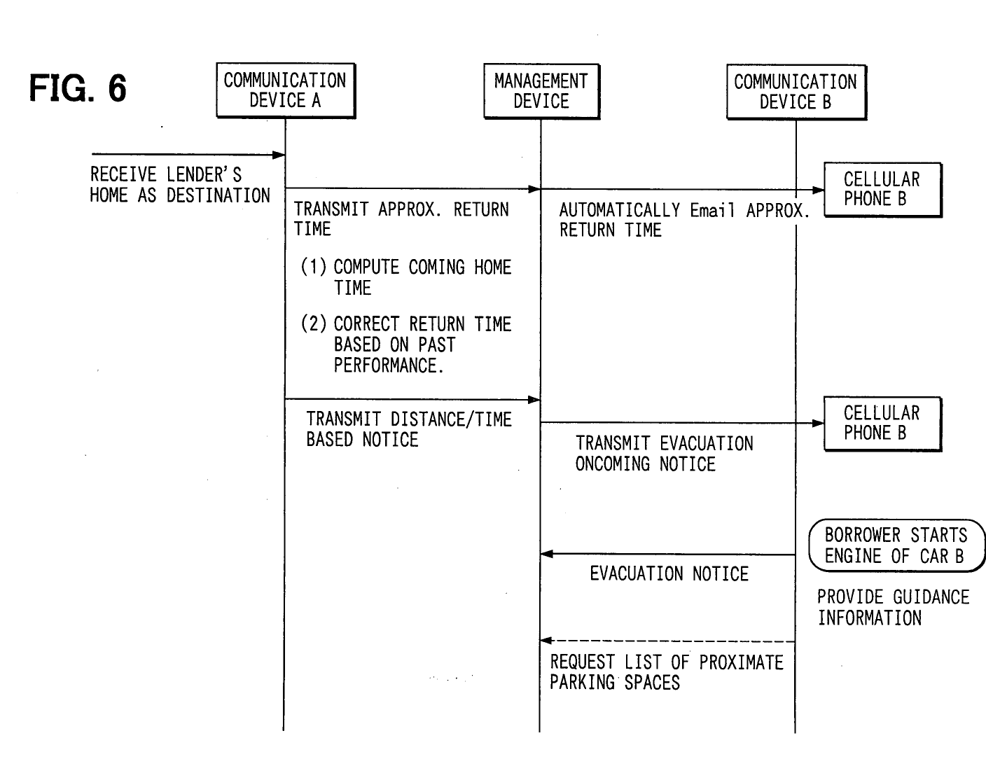

The operation of a parking stall rental support system of this embodiment will now be described with reference to FIGS. 4-9.

A prospective lender first operates the operation switch group 22 or remote 23a to set a traveling destination other than his/her own home. This means that the prospective lender intends to vacate his/her parking space for some period of time, thereby making it available for rent. The lender's communication device A performs a route computation and computes an approximate return time and transmits it to the parking space management device 50.

Here, description will be given to the computation of the approximate return time. First, the earliest approximate return time t1 is computed. For example, the time required for traveling to and from the destination on the assumption that the vehicle speed is 80 km/h for express highways and 30 km/h for other roads. In this case, the time may be corrected taking into account, for example, traffic jam information obtained from the VICS or information on touring time. Next, a residence time at the destination is estimated according to a classification of the destination. The estimated residence time is added to the earliest approximate return time t1 to determine an approximate return time t2. For example, when it is a weekday and the destination is set as the place of work, the residence time is estimated on the assumption that the prospective lender will come home in the evening. For example, the residence time may be set to nine hours. However, if the destination is set to be a movie theater, the residence time may be set to only two hours.

When the lender's communication device A is provided with a function of recording the time required to arrive at a destination or the residence time mentioned above, the earliest approximate return time t1 and the approximate return time t2 may be corrected based on the past performance of the lender.

Instead of estimating the above-described times, information for identifying the lending period may be preset according to the destination to which the prospective lender intends to travel. For example, when it is a weekday and the place of work is set as the destination, the lending period may be pre-set for a time period until 7:00 in the evening. However, even when the prospective lender goes to work, his/her schedule may change from time to time, thereby changing the availability of their parking space for rent. To cope with this, the following constitution may be adopted: the prospective lender inputs information identifying his/her schedule via a hand-held terminal, such as a PDA or a cellular phone, through the external information input/output device 24 illustrated in FIG. 2. The approximate return time is then computed based on the inputted schedule information. More specifically, when schedule management software is used on a hand-held terminal, such as a PDA, a possibility exists that the prospective lender's schedule set by the prospective lender him/herself is stored therein as data. Consequently, when that information is acquired to set the approximate return time, a more accurate return time can be approximated.

The approximate return time is then transmitted together with the parking space ID from the communication device A to the parking space management device 50. Parking space ID's are stored on the hard disk 28. (Refer to FIG. 2.) Upon receiving the approximate return time as well as the parking space ID, the parking space management device 50 enters the information into the parking space list illustrated in FIG. 3. More specifically, with respect to the lending period in the relevant file selected from the parking space list based on the parking space ID, the following operation is performed: the period from the current time obtained from the calendar clock 54 to the above-mentioned approximate return time (e.g. 8:00 to 20:00) is entered, and “available” is set as the utilization. Thus, the parking space of this parking space ID is brought into a state in which someone can borrow it.

It should be appreciated that the supplemental guidance information may also be transmitted with the approximate return time. As mentioned above, the supplemental guidance information is guidance information includes an operating method for equipment such as a door or multilevel car parking tower, coordinate data indicating the positions of the entrances and exits of an apartment block, track data for entry indicating routes connecting entrances to the parking space, track data for exit indicating routes connecting the parking space and exits to public roads, and left/right turn and landmark data. This information is basically generated by the prospective lender and transmitted to the parking space management device 50. The information regarding operating methods for equipment such as the door and the multilevel car parking tower can be separately generated by the prospective lender using a personal computer or similar device. Then the information can be transmitted to the parking space management device 50 from the communication device A or from the personal computer that generated the information. The track data for entry and exit can be generated by the communication device A when the car A mounted with the communication device A runs.

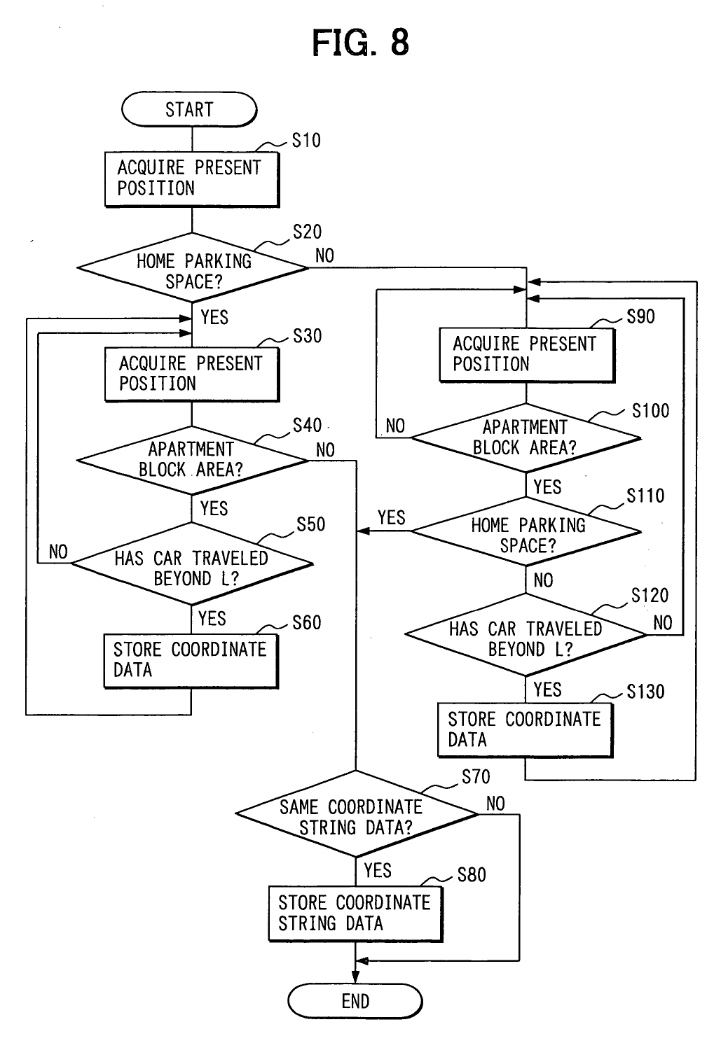

The processing related to the generation and transmission of the track data for entry and exit will now be described with reference to the flowchart in FIG. 8.

The processing illustrated in FIG. 8 is performed when the engine is on.

First, at S10, the present position is acquired. The position data of the parking space of the prospective lender's own home is stored on the hard disk 28. Therefore, this position of the home parking space is compared with the present position acquired at Step S10 and it is determined whether the present position is the home parking space or not at S20. When the present position is judged to be the home parking space (S20: YES), the loop processing of Steps S30 to S60 is performed to generate track data for exit.

In this loop processing, the present position is acquired at S30, and it is determined whether the present position is in the apartment block area or not at S40. (Refer to FIG. 7.) The position data indicating the apartment block area is stored on the hard disk 28. When the present position is in the apartment block area (S40: YES), it is determined whether the car has traveled beyond a predetermined distance L at S50. Each time the car has traveled beyond the predetermined distance L (S50: YES), the coordinate data at that point of time is acquired and stored on the hard disk 28 at S60. Therefore, coordinate string data that is updated with coordinate data obtained each time the car travels beyond the distance L is stored on the hard disk 28.

When the car gets out of the apartment block area (S40: NO), it is determined whether the same coordinate string data exists on the hard disk 28 or not at S70. When the same coordinate string data exists (S70: NO), the processing is terminated. When the same coordinate string data does not exist (S70: YES), the coordinate string data is stored as track data for exit on the hard disk 28 at S80. In case of the example in FIG. 7, the following operation takes place: when the car goes from the parking space of A and gets out to the public road 1 through route 12 to the entranceway 1, the coordinate string data corresponding to route 12 is stored. When the car takes route 11, a negative determination is made at Step S70. When the car goes from the parking space of A and gets out to the public road 2 through route 22 to the entranceway 2, the coordinate string data corresponding to route 22 is stored as track data for exit on the hard disk 28 at S80. After the coordinate string data corresponding to route 12 and route 22 are stored on the hard disk 28, as mentioned above, no data is stored at Step S80 unless any other route is taken.

When the present position is not the home parking space (S20: NO), the loop processing of Steps S90 to S130 is performed to generate track data for entry. More specifically, the present position is acquired at S90 and it is determined whether the present position is in the apartment block area or not at S100. The processing of Steps S90 and S100 is repeatedly performed as long as the car does not go into the apartment block area (S100: NO). When the car goes into the apartment block area (S100: YES), it is determined whether the present position is the home parking space or not at S110. More specifically, in case of the example illustrated in FIG. 7, affirmative judgment at Step S100 means that the car has entered the apartment block area from the public road 1 or the public road 2. Therefore, coordinate string data indicating the route from there to the home parking space is generated. Specifically, when the present position is not the home parking space (S110: NO), it is determined whether the car has traveled beyond the predetermined distance L at S120. When the car has traveled beyond the predetermined distance L (S120: YES), the coordinate data at that point of time is acquired and stored on the hard disk 28 at S130, and the operation returns to Step S90. Therefore, coordinate string data that is updated with coordinate data obtained each time the car travels beyond the distance L is stored on the hard disk 28.

When the car arrives at the home parking space (S110: YES), it is determined whether the same coordinate string data exists on the hard disk 28 or not at S70. When the same coordinate string data exists (S70: NO), the processing is terminated. When the same coordinate string data does not exist (S70: YES), the coordinate string data is stored as track data for entry on the hard disk 28 at S80. In case of the example in FIG. 7, the following operation takes place: when the car takes route 11 from the entranceway 1 and arrives at the parking space of A, the coordinate string data corresponding to route 11 is stored. When the car takes the same route 11, negative judgment is made at Step S70. When the car takes route 21 from the entranceway 2 and arrives at the parking space of A, the coordinate string data corresponding to route 21 is stored as track data for entry on the hard disk 28 at S80. After the coordinate string data corresponding to route 11 and route 21 are stored on the hard disk 28, as mentioned above, no data is stored at Step S80 unless any other route is taken.

When coordinate string data corresponding to track data for entry or exit is stored on the hard disk 28, it may be transmitted to the parking space management device 50 at the same time. In this case, the coordinate string data is transmitted together with the relevant parking space ID.

For example, the prospective borrower operates the operation switch group 22 or the remote 23a and sets a friend's home as the destination that is in close proximity to a prospective lender's parking space. Communication device B performs route computation based on the set destination. At the same time, communication device B requests the list of vacant parking spaces in proximity to the destination. At this time, communication device B only has to notify the parking space management device 50 of the position information of the destination at minimum. However, information about conditions for the prospective borrower's car and the desired parking space may be added. An example of the information about the conditions is information about the size or height of the car, and an example of the information about the desired parking space is that the prospective borrower desires a paved parking space.

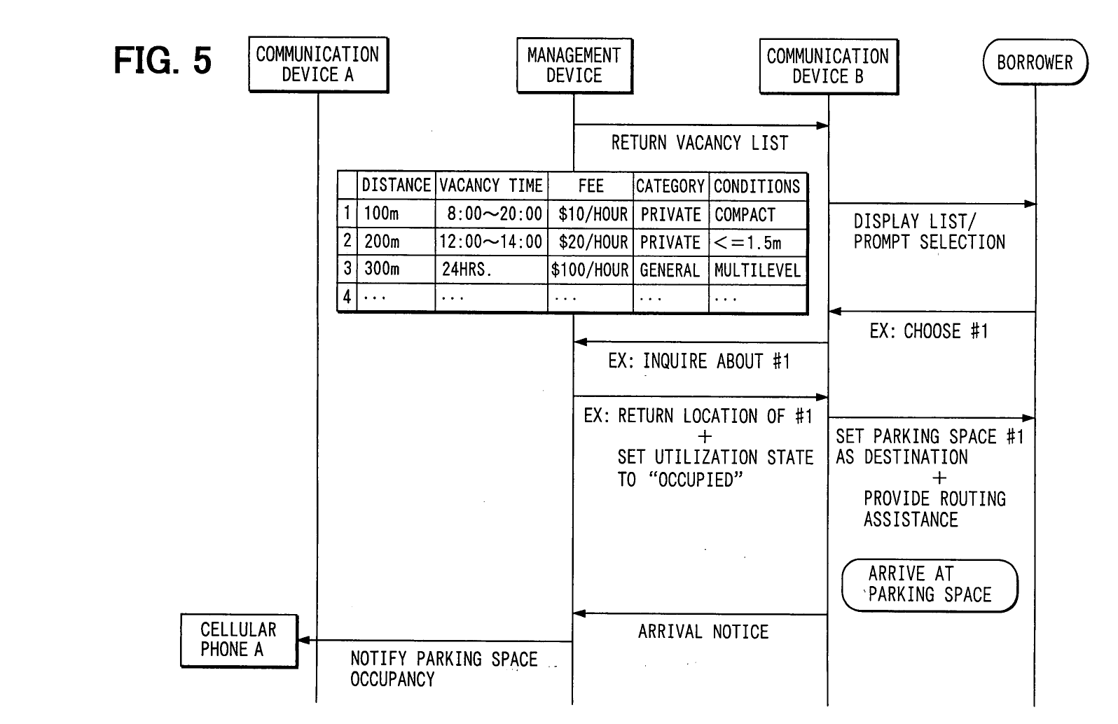

When requested by the communication device B, the parking space management device 50 generates the vacant parking space list and replies to the communication device B. More specifically, based on the position information of the destination, the parking space management device 50 extracts files that meet all of the following conditions: the parking space should be located at a specified distance from the destination, for example, within a radius of 500 m; when there are the above-mentioned conditions, the conditions should be met; and the utilization state should be set to “available.” Then the parking space management device 50 sorts the extracted files in the order of proximity to the destination. Thus, the parking space management device 50 generates the vacant parking space list, as illustrated in FIG. 5, in which data is compiled with respect to the items of distance, vacant time, fee, category, and conditions. An example of files is such that distance: 100 m, vacant time: 8:00 to 20:00, fee: $10/hour, category: private; and conditions: compact car. As mentioned above, the parking space list 52a also contains the information of the parking lots of operators who provide them as a commercial business. An example of files in this case is such that distance: 300 m, vacant time: 24 hours, fee: $100/hour, category: general, and conditions: multilevel car parking tower.

Upon receiving the vacant parking space list from the parking space management device 50, the communication device B displays this list on the display unit 26. (Refer to FIG. 2.) In addition to this list, the communication device B may prompt the user to “Select Any.” When a touch panel is integrally formed with the display unit 26 and is provided above the display screen is adopted as the operation switch group 22, the prospective borrower can select any parking space by touching the touch panel. Alternatively, the prospective borrower may make a selection using the remote 23a.

When a parking space is selected from the vacant parking space list, the communication device B requests information regarding the parking space from the parking space management device 50. At this time, the prospective borrower ID is also transmitted to the parking space management device 50. The parking space management device 50 extracts the position of the parking space from the parking space list 52a and transmits it to the communication device B. When the particular parking space includes supplemental guidance information (Refer to FIG. 3), the parking space management device 50 also transmits this. Until this point in time, the utilization state of the parking space has been set to “vacant” in the parking space list 52a. Therefore, the state is changed to “occupied” at this time and the received prospective borrower ID is entered into the field of prospective borrower ID.

Upon receiving the position information of the parking space and any supplemental guidance information associated therewith form the parking space management device 50, communication device B performs route computation with that position taken as the destination and provides routing assistance based on the set route. When any supplemental guidance information is set with respect to the parking space, the communication device B provides such guidance as described below according to the contents of the supplemental guidance information.

As mentioned above, the supplemental guidance information can contain two different types of information. It may include information regarding an operating method for equipment and/or guidance information for navigating an apartment block. When the supplemental guidance information contains only an operating method for equipment, the communication device B caries out normal route computation and provides guidance with the position of the parking space taken as the destination. When the car arrives at the parking space, the communication device B informs the driver of the operating method for equipment through the display unit 26 or the audio output device 27. For example, when the parking space is provided with a door or is in a multilevel car parking tower and some kind of equipment operation is required, the communication device B informs the driver of the operating method for the equipment.

When guidance information for navigating an apartment block exists, the communication device B provides such guidance as described below. As mentioned above, the guidance information for navigating the apartment block includes: coordinate data indicating the positions of the entrances and exits of an apartment block; track data for entry indicating routes connecting the entrances and a parking space as an object for rent; track data for exit indicating routes connecting the parking space as an object for rent and the exists to public roads; left/right turn and landmark data; and the like. When the guidance information for navigating the apartment block only contains coordinate data indicating the positions of the entrances and exits of an apartment block at this time, the following takes place: the communication device B performs route computation and provides guidance with an entrance taken as the destination. When two entranceways 1 and 2 exist, as illustrated in FIG. 7 as an example, the communication device B operates as follows: it performs route computation with both the entranceways taken as the destinations, selects the entranceway by which the distance will be reduced, and provides routing assistance with this entranceway taken as the destination.

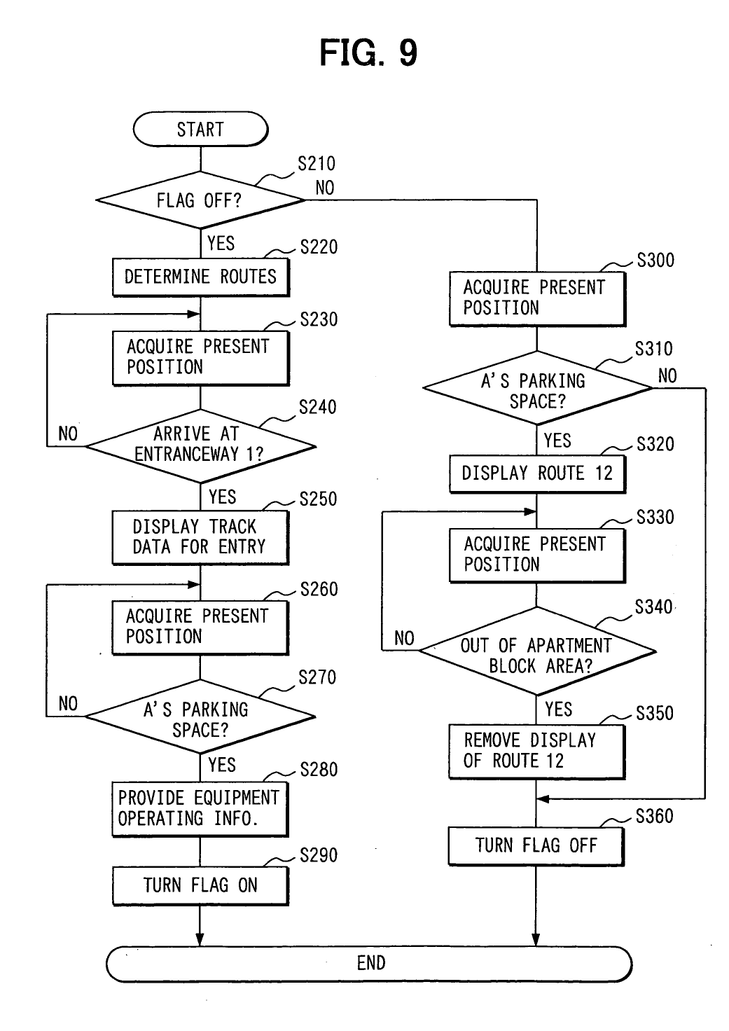

When the guidance information for navigating the apartment block contains track data for entry, track data for exit, and left/right turn and landmark data as well as coordinate data indicating the positions of the entrances and exits of the apartment block, the communication device B performs the guidance processing illustrated in FIG. 9. The guidance processing illustrated by the flowchart of FIG. 9 will now be described.

First, it is determined whether a flag is OFF or not at S210. Since the initial state of the flag is OFF (S210: YES), the operation proceeds to Step S220. Route computation is performed with respect to the entranceways 1 and 2, guidance is started with the entranceway at the shorter distance taken as the destination. At the same time, routes to be used in the apartment block are determined, and the operation proceeds to Step S230. Here, description will be given based on the example in FIG. 7. The following description is based on the assumption that the routes with the entranceway 1 taken as the destination are taken as the routes at the shorter distance; and as a result, the routes 11 and 12 are determined as the routes to be used in the apartment block.

Based on the present position acquired at Step S230, it is determined at Step S240 whether the car has arrived at the entranceway 1 or not. While the processing of Steps S230 and S240 is performed, the routing assistance started at Step S220 is carried on. When the car mounted with the communication device B runs on the public road 1 illustrated in FIG. 7 and arrives at the entranceway 1 (S240: YES), the route 11 is displayed on the display unit 26 using the track data for entry at S250. Therefore, when the driver takes the displayed route 11, he/she can easily make it to the parking space of A. After the route is displayed at S250, the present position is acquired at S260. Then it is determined whether the car has arrived at A's parking space at S270, and the processing of Steps S260 and S270 are repeated until the car arrives at A's parking space. When the guidance information for navigating the apartment block contains left/right turn and landmark data, the following operation is performed though this is not illustrated in FIG. 9. It is determined by comparison whether the present position is the position where notification should be executed using the left/right turn and landmark data. When the car arrives at the execution position, notification is executed using the left/right turn and landmark data. Concrete examples of possible notification include: provision of audio guidance or character representation telling “turn right (left),” and/or display of a billboard as a landmark.

When the car arrives at A's parking space with the aid of such guidance on routes in the apartment block (S270: YES), the operating method for any equipment is notified through the display unit 26 or audio output device 27 at S280. However, this operation is performed only when the information of operating method for equipment exists. Then the flag is set to ON at S290 and the processing is terminated.

When the car arrives at the parking space of the destination, the communication device B notifies the parking space management device 50 of the arrival. This notification of arrival may be carried out just when the car is judged to have arrived at the destination based on the position information. Alternatively, it may be carried only when after the arrival at the destination, the engine of the car B mounted with the communication device B is stopped. Since the notification is carried out after the car is parked in the latter case, it is more reliable.

Upon receiving this notification, the parking space management device 50 transmits to the lender's cellular phone A information indicating that the use of the parking area has been started. This notification may be performed even by textual information by e-mail. Thus, the lender can learn that his/her parking space is occupied by someone regardless of whether the lender is in the car A or out of the car A.

When the lender operates the operation switch group 22 or the remote 23a to set his/her own home as the destination, the communication device A performs route computation. At the same time, the communication device A computes the approximate return time and transmits it to the parking space management device 50. In this case, the computation can be performed based on the time required for making it to the destination, that is, coming back home (one way). Alternatively, the computation of the time required can be performed as described above. That is, the computation may be carried out on the assumption that the vehicle speed is 80 km/h for express highways and 30 km/h for other roads. Additionally, the time required may be corrected taking into account, for example, traffic jam information obtained from the VICS and information on touring time. Furthermore, the correction may be made based on the lender's past performance.

The computed approximate return time is transmitted together with the parking space ID from the communication device A to the parking space management device 50. Upon receiving the approximate return time and the parking space ID, the parking space management device 50 identifies the borrower ID based on the parking space list illustrated in FIG. 3. Then the parking space management device 50 extracts the phone number of the cellular phone B corresponding to the borrower ID from the prospective borrower list 52c. The parking space management device 50 transmits the approximate return time to the cellular phone B by e-mail. Thus, the borrower can learn the lender's approximate return time and be apprised of when he/she must remove car B from the borrowed parking space. As described above, the vacant parking space list is displayed on the display unit 26 before then. In case of the parking space illustrated in FIG. 5, the prospective borrower can learn from the display that he/she must evacuate the parking space by 20:00. However, this is only a plan and there is a possibility that the lender will come home after the displayed time. When the approximate return time computed to be 21:00, for example, the borrower can borrow the parking space until he/she desires within the confines of the displayed time. However, when the approximate return time is pushed forward to 19:30, for example, the borrower must be apprised of such change. Therefore, a notification is sent to the borrower approximately one hour prior to the approximate return time, approximately 18:30, thereby enabling the borrower to prepare to evacuate the parking space by the actual return time.

The approximate return time transmitted to the borrower, as described above, is only an estimated time and the actual return time may be before or after that time. Furthermore, even when the lender returns on schedule, problems may arise. For example, when the approximate return time is later than, for example, two hours or more, from when the notification was transmitted to the borrower, the borrower may forget the approximate return time. Therefore, the approximate return time is preferably announced again shortly before the lender's return time. When the lender is within a predetermined distance from the lender's parking space (destination), the lender's communication device A transmits a an incoming notice to the parking space management device 50. Upon receiving this incoming notice, the parking space management device 50 transmits an e-mail to the borrower's cellular phone B. The e-mail states that the lender's car A is returning to the parking space and prompts the borrower to evacuate the parking space. In one embodiment, the predetermined distance for triggering the incoming notice may be set based on time, as opposed to actual distance, for example, 5 minutes or 10 minutes. It may be preferable that the approximate return time should be periodically computed and the incoming notice be transmitted when the car will arrive within a predetermined period of time equal to 5 or 10 minutes, for example.

When the borrower receives the incoming notice, the borrower learns that he/she ought to immediately get ready to remove his/her car from the borrowed parking space. Conversely, when the borrower receives notification of an approximate return time, as described above, a problem may arise. For example, when the notification is made one hour before the approximate return time, the borrower must continuously remind him/herself of the return time. Therefore, when the incoming notice is also provided, the borrower only has to wait for the oncoming notice and need not worry about the approximate return time.

When the borrower goes to the parking space and starts the engine, evacuation notification is made from the communication device B to the parking space management device 50. On receipt of this evacuation notification, the parking space management device 50 changes the utilization state in the parking space list 52a to “unavailable.”

The borrower may desire to move his/her car B to any nearby parking space and further park the car B. In this case, the borrower sets the same destination again, and thereby requests the vacant parking space list of the parking space management device 50, as described above. The subsequent operation is the same as described above.

When the parking space of A is located in a parking lot of the apartment block, the processing illustrated in FIG. 9 is performed. More specifically, it is determined whether the flag is OFF at S210. As mentioned above, the flag was set to ON at Step S290; therefore, negative judgment is made here, and the operation proceeds to Step S300. The present position is acquired at Step S300, and it is determined whether the present position is A's parking space. When the car is positioned at A's parking space (S310: YES), route 12 is displayed on the display unit 26 using the track data for exit at S320. In this example, it was determined at Step S220 that route 12 would be taken, and thus the display is carried out using the track data for exit corresponding to the route 12. Therefore, when the driver takes the displayed route 12, he/she can easily arrive at the entranceway 1 from A's parking space. After the route is displayed at S320, the present position is acquired at S330 and it is determined whether the car has gotten out of the apartment block area (S340). The processing of Steps S330 and S340 is repeated until the car gets out of the apartment block area. When the guidance information on apartment block contains left/right turn and landmark data, the following operation is performed though this is not illustrated in FIG. 9: it is determined by comparison whether the present position is the position where notification should be executed using the left/right turn and landmark data. When the car arrives at the execution potion, notification is executed using the left/right turn and landmark data.

When the car gets out of the apartment block area with the aid of such guidance on routes in the apartment block (S340: YES), the display of the route 12 is removed at S350. Then the flag is set to OFF at S360 and the processing is terminated.

In a parking stall rental support system in this embodiment, as mentioned above, the parking space list generated based on the prospective lender ID plus the approximate return time transmitted from the prospective lender 's communication device A is stored in the parking space management device 50. Therefore, the prospective borrower's communication device B can search the parking space list with arbitrary timing and receive the vacant parking space list from the parking space management device 50. Then the communication device B can inform the prospective borrower of that vacancy. The prospective borrower can refer to the vacant parking space list and learn whether there is any parking space he/she desires to borrow. That is, the prospective borrower can learn whether there is any parking space in an area where he/she desires to borrow it and whether he/she can borrow the parking space only for the period he/she desires. When a parking space that meets the prospective borrower's requirements exists, he/she can borrow it. In case someone lends his/her private parking space only for a period for which he/she does not use the parking space, the rental fee is prone to be relatively low as compared with ordinary parking spaces rented by operators in commercial businesses. Therefore, prospective borrowers' demand for parking spaces provided by individuals is expected to grow. With a system according to the present invention, lending and borrowing of parking spaces as objects for rent can be appropriately performed and the effective utilization of the parking spaces can be facilitated. Even a private parking space can be lent to someone else when it is not used, and as a result, unauthorized parking can be reduced.

When a parking space as an object for rent is a parking space in such an apartment block as illustrated in FIG. 7, an entrance from a public road is taken as the destination instead of the parking space as an object for rent when routing assistance is carried out. As the result of routing assistance, the driver can arrive at an entrance to an apartment block, for example. Thus, the driver of the car mounted with communication device B need not become confused in an attempt to find an entrance by him/herself. In the example in FIG. 7, the entranceways are used both as entrances and as exits. When gateways are used exclusively as entrances or exits, the following trouble may occur: the user finds a gateway that looks like an entranceway by him/herself, and enters the apartment block through the gateway. However, the gateway is actually an exit, and the user finds him/herself driving in the opposite direction. According to this embodiment, such inconvenience can be avoided.

Even after the driver makes it to an entrance to an apartment block, he/she may have difficulty. In some cases, after the driver goes into the apartment block, he/she may be able to easily arrive at an intended parking space as an object for rent. In other cases, the apartment block may be huge, and routes leading from entrances to the apartment block to the parking space or routes leading from the parking space to exits from the apartment block may be complicated. The prospective lender is an inhabitant of the apartment block and is familiar with the routes. However, a person who borrows the parking space for the first time may want routing assistance even in the apartment block. In this embodiment, driver-friendly routing guidance for navigating an apartment block can also be provided. When routes leading from entrances to an apartment block to a parking space as an object for rent or routes leading from the parking space to exits from the apartment block are complicated, the driver may yet fail to smoothly drive only with track indication. To cope with this, this embodiment is so constituted as to provide such left/right turn assistance or landmark guidance as car navigation devices provide in routing assistance during road driving, and thus implement smoother guidance.

Some parking spaces as objects for rent are not so constructed that drivers can simply park cars and may require some equipment operation because they are provided with a door or they are multilevel car parking towers. Those whose lend parking spaces are familiar with such operating methods for equipment, but those who borrow such a parking space for the first time do not know how to operate the equipment. Therefore, after one goes all the way to a parking space, he/she can get confused about what to do. To cope with this, this embodiment is so constituted as to inform the user of how to operate equipment. Examples of such information include how to open (and close) a door, how to move down an upper-level parking stall in case one attempts to park his/her car at the upper level of a two-leveled car parking tower, and the like. Thus such situations that a driver does not know the operating method for equipment and has trouble can be avoided.

The above embodiment provides that when a destination is set on the prospective borrower's communication device B, the communication device B requests the vacant parking space list from the parking space management device 50. In an alternative embodiment, the prospective borrower may enter conditions such as a desired location for a parking space and/or a desired date and hour into the parking space management device 50 in advance. When a parking space fulfilling the conditions is found in the parking space management device 50, that information is transmitted to the communication device B or the cellular phone B.

The above embodiment provides that the communication device B displays the vacant parking space list, received from the parking space management device 50, and a parking space selected from the list is just transmitted from the communication device B to the parking space management device 50. In an alternative embodiment, however, the period for which the prospective borrower desires to utilize the parking space may be transmitted as well. This is because the prospective borrower not always uses the parking space throughout the lending period. In this case, the lender can take into account the desired lending period from the communication device B and can lend the parking space to any other person for the remaining period of time. Therefore, scheduling can be carried out using the parking space management device 50. For example, it is assumed that the lending period from the prospective lender is 8:00 to 20:00 and the desired borrowing period from the first prospective borrower is 9:00 to 12:00. In this case, processing is performed so as to take the period from 12:00 to 20:00 as the vacant time and enter the parking space into the vacant parking space list with respect to this period.

The description of the above embodiment does not refer to fee settlement in detail. The parking space management device 50 holds the account numbers of prospective lenders and prospective borrowers and can calculate tolls according to the parking time. The calculated tolls can be settled using a publicly known toll settlement system. For example, information required for settlement can be transmitted to a separately provided settlement server and settlement can be carried out at the settlement server. An ETC road unit may be installed at each parking space. When the communication device B is also provided with the functions of ETC onboard unit, tolls can be settled by the ETC system.

The above embodiment provides that the approximate return time is computed when a destination is set on the communication device A. However, the present invention is not limited to this configuration. For example, the prospective lender may go to somewhere by the car A, train, and plane. In this case, the present invention can be linked with systems for reading information on train tickets and air tickets. Thus, when the prospective lender goes through a ticket gate in a railroad station or a boarding gate in an airport, the information can be read and the approximate return time can be computed with this information taken into account when the information is read.

In the above embodiment, the objects for rent are parking spaces. In alternative embodiments, the objects for rent may include any other immovable properties or even movable properties such as automobiles.

In the above embodiment, many unspecified persons are assumed as prospective borrowers. For this reason, the parking space management device 50 is indispensable. When an automobile is lent and borrowed between specified persons, such as family members and friends, equipment for transferring information, such as the above-mentioned parking space management device 50, is unnecessary. This is because information only has to be communicated between cellular phones, for example, and trouble is less prone to occur even when specified persons give the phone numbers of their cellular phones to each other.

When lending and borrowing of an automobile are implemented through each other's cellular phones, for example, the following constitution may be adopted: the prospective lender enters into his/her cellular phone a period for which he/she can lend his/her car and the prospective borrower accesses the information with his/her cellular phone. Thus, when a family member or a friend desires to borrow the car, the family member or friend can easily learn whether he/she can borrow it.

Lending information is transmitted from the prospective lender's cellular phone only after access is made from the prospective borrower's cellular phone. Instead, lending information may be proactively transmitted from the prospective lender's cellular phone to the prospective borrowers'. cellular phones. In this case, when the prospective lender enrolls a period for which he/she can lend his/her car, lending information is automatically transmitted from the prospective lender's cellular phone to the prospective borrowers' cellular phones. On receipt of this lending information, the prospective borrowers' cellular phones inform the prospective borrowers of the received lending information. In such information communication, information can be adequately transmitted as textual information by e-mail. Even when lending information is proactively transmitted, an excessive burden will not be produced because the destinations of transmission are family members or friends and relatively small in number.

Even in such a rental support system, devices can be made in case a lending period is changed according to the lender's convenience. More specifically, when a predetermined return request occurs, the lender's communication device transmits at least return information that can identify the object for rent, the return of which the lender desires to request to the borrower's communication device. Upon receiving this return information, the borrower's communication device informs the borrower of the received return information. When the communication devices are cellular phones, for example, return information can be transmitted as textual information using e-mail functions, and can be displayed on the screen. Alternatively, return information may be announced by voice. Even when a return request is made through the lender's manual operation, it is preferable that the return request be implemented through simple operation. Therefore, the following constitution can be adopted: return information is stored as a repetitive document in the communication device on the lender side in advance; when some simple operation is performed, the return information is automatically transmitted to the communication device on the borrower side.

When the object for rent is an automobile, return information may be announced by a car navigation device, for example. More specifically, the following constitution may be adopted: the car as an object for rent is provided with a communication device. Instead of transmitting return information to the borrower's communication device, the lender's communication device transmits it to the communication device provided in the object for rent. Alternatively, the lender's communication device transmits the return information to the communication device provided in the object for rent in addition to the borrower's communication device. On receipt of the return information, the communication device provided in the object for rent informs the borrower of the received return information. This will bring the following advantage: when the car is in use, return information is announced from the onboard device; therefore, notification to the borrower is carried out with higher reliability. When the communication device on the borrower side is a cellular phone, for example, the following problem arises: when the borrower is driving the car, he/she may have difficulty in operating the cellular phone or viewing the screen display. However, when return information is displayed on the onboard monitor or is automatically announced by voice, the borrower can grasp the return information in safety with reliability even when he/she is driving the car.

When one lends a private parking space to someone else, for example, neighbors who do not understand the situation may feel insecure about a strange car occupying the neighbor's parking space. To ease people's apprehension, a number of devices can be implemented to ease insecurity.

For example, the number, features, and other information of the borrower's car may be stored in the parking space management device 50. If a neighbor thinks the car is suspicious, he/she can access the parking space management device 50 to identify the car that should be parked there.

Additionally, the lender's phone number may be stored in the parking space management device 50. Thus, a suspicious neighbor may access the parking space management device 50 to retrieve the number and contact the lender to identify the car. Alternatively, an automatic response may be provided to a neighbor's inquiry stating that the lender's parking space is now on loan to someone else.

1. A rental support system comprising:
a first communication device;
a second communication device; and
a server in data communication with the first communication device and the second communication device,
wherein the first communication device transmits enrollment information to the server, the enrollment information identifying at least one object for rent and a lending period,
wherein upon receiving the enrollment information, the server stores lending information that is based on the enrollment information in an information database,
wherein the second communication device transmits request information to the server to identify the at least one object for rent,
wherein upon receiving the request information, the server searches the information database for lending information corresponding to the request information and transmits a lending information list obtained as the result of the search to the second communication device, and
wherein upon receiving the lending information, the second communication device announces the lending information list.

2. The rental support system according to claim 1,
wherein the at least one object for rent is a parking space, and
the first communication device is mounted in a vehicle and includes a routing assistance function that generates the enrollment information when a destination other than the parking space is set.

3. The rental support system according to claim 1,
wherein the object for rent is a parking space and the first communication device is mounted in a vehicle and is provided with a routing assistance function that generates the enrollment information when the vehicle moves within a predetermined distance from the parking space.

4. The rental support system according to claim 2,
wherein the lending period is computed based on at least the sum of a time required for the vehicle to depart and return to the parking space and a residence time defined as an amount of time estimated to be spent at the destination.

5. The rental support system according to claim 3,
wherein the lending period is computed based on at least the sum of a time required for the vehicle to depart and return to the parking space and a residence time defined as an amount of time estimated to be spent at the destination.

6. The rental support system according to claim 2,
wherein the lending period is a preset period according to the destination.

7. The rental support system according to claim 2,
wherein the first communication device includes a hand-held terminal containing a schedule associated with the parking space that defines the lending period based on the schedule.

8. The rental support system according to claim 2,
wherein the second communication device includes a routing assistance function for providing routing assistance to the parking space selected from the lending information list.

9. The rental support system according to claim 8,
wherein the lending information also contains point data identifying entrances between public roads and the parking space to supplement the routing assistance of the second communication device, and
wherein when the point data exists, selected from the lending information list received from the server, the second communication device provides routing assistance including the entrances from the public roads.

10. The rental support system according to claim 9,
wherein the lending information also contains track data for entry identifying routes between entrances from public roads and the parking space and track data for exit identifying routes between the parking space and exits to public roads, the entry and exit track data used when routes between the public roads to the parking space are not included in the routing assistance of the second communication device,
wherein upon arrival at the entrance from the public road, the second communication device displays a track connecting the entrance from the public road to the parking space based on the track data for entry, and
upon departing from the parking space, the second communication device displays a track between the parking space and the exit to the public road based on the track data for exit.

11. The rental support system according to claim 10,
wherein the track data for entry and the track data for exit are generated by the first communication device when the vehicle mounted with the first communication device runs and is included in the enrollment information transmitted to the server.

12. The rental support system according to claim 10,
wherein the lending information contains at least one of data for left turn assistance and right turn assistance, the data being useful when driving according to one of the track data for entry and the track data for exit and data indicating landmarks, and
wherein when displaying a track based on one of the track data entry and the track data for exit, the second communication device also provides routing assistance based on at least one of the data for left turn assistance, the data for right turn assistance, and the data indicating landmarks.

13. The rental support system according to claim 2,
wherein the lending information also contains data identifying an operating method for operating equipment required when parking a car in the parking space, and
the second communication device includes an information announcing function for announcing the operating method for the equipment based on the data identifying the operating method.

14. The rental support system according to claim 13,
wherein the second communication device includes a routing assistance function that announces the operating method for the equipment upon arriving at the parking space.

15. The rental support system according to claim 8,
wherein upon arriving at the parking space as the result of the routing assistance, the second communication device notifies the server of an emergency contact for the borrower of the parking space as an object for rent.

16. The rental support system according to claim 15,
wherein when the parking space is set as the destination, the first communication device notifies the server of the approximate return time at the parking space, and
upon receiving the approximate return time, the server notifies the second communication device of the approximate return time and the borrower's emergency contact.

17. The rental support system according to claim 16,
wherein when approaching a predetermined distance from the parking space, the first communication device transmits an incoming notice to the server, and
upon receiving the incoming notice, the server transmits the incoming notice to the second communication device along with a request to evacuate the parking space to the emergency contact for the borrower of the parking space as an object for rent.

18. The rental support system according to claim 2,
wherein the object for rent includes a plurality of parking spaces and the lending information list contains the location each parking space, their lending periods, fees, and conditions related to vehicles that can be parked there.

19. The rental support system according to claim 2,
wherein the request information transmitted from the second communication device to the server includes conditions on the object for rent.

20. A communication device for use in a rental support system, comprising:
a storage device for storing enrollment information for an object to be rented, said enrollment information including at least one of a location of the object for rent, a rental fee, a lender ID, a lending period, point data identifying entrances between the object for rent and public roads, track data for entry identifying routes between the entrances and the object for rent, track data for exit identifying routes between object for rent and at least one of the entrances and an exit, and an operating method for operating equipment associated with the object for rent;
a transmitter for transmitting the enrollment information to a server; and
a processor for computing an approximate return time and sending said approximate return time to a server.

21. A communication device for use in a rental support system, comprising:
a transmitter for transmitting a request including a destination to a server to rent an object for rent;
a receiver for receiving a lending information list from the server containing information on at least one object for rent, said information including at least one of a location of the object for rent, a rental fee, a lender ID, a lending period, point data identifying entrances between the object for rent and public roads, track data for entry identifying routes between the entrances and the object for rent, track data for exit identifying routes between object for rent and at least one of the entrances and an exit, and an operating method for operating equipment associated with the object for rent; and
a display device for displaying the lending information.

22. A server for use in a rental support system, comprising:
a storage device for storing lending information corresponding to at least one object for rent;
a receiver for receiving enrollment information from at least one lender communication device and request information from at least one borrower communication device,
said enrollment information including at least one of a location of the object for rent, a rental fee, a lender ID, a lending period, point data identifying entrances between the object for rent and public roads, track data for entry identifying routes between the entrances and the object for rent, track data for exit identifying routes between object for rent and at least one of the entrances and an exit, and an operating method for operating equipment associated with the object for rent,
said request information including at least destination information; and
a transmitter for transmitting a lending list to said borrower communication device, said lending list generated according to said request information.

23. A rental support system comprising:
a first communication device and a second communication device in data communication with each other,
wherein the first communication device stores lending information including at least an object for rent and a lending period,
the second communication device transmits request information to the first communication device,
upon receiving the request information from the second communication device, the first communication device transmits the lending information that corresponds to the request for information and identifies an object for rent to the second communication device, and
upon receiving the lending information from the first communication device, the second communication device announces the received lending information.

24. A rental support system comprising:
a first communication device and a second communication device in data communication with each other,
wherein the first communication device transmits lending information to the second communication device, the lending information identifying at least an object for rent and a lending period, and
wherein upon receiving the lending information from the first communication device, the second communication device announces the lending information.

25. The rental support system according to claim 23,
wherein the first communication device transmits a return request to the second communication device, the return request identifying at least the object for rent and requests its return, and
wherein upon receiving the return request from the first communication device, the second communication device announces the request.

26. The rental support system according to claim 25,
wherein the object for rent is a vehicle further including a third communication device,
wherein the first communication device transmits the return request to at least the third communication device, and
upon receiving the return information from the first communication device, the third communication device announces the request.

27. A communication device mounted to a vehicle for use in a rental support system, comprising:
a storage device for storing lending information including a plurality of objects for rent;
a receiver for receiving a request from an external communication device; and
a transmitter for transmitting a portion of the lending information that corresponds to the request to the external communication device and a return request to the external communication device, the return request identifying at least the object for rent and requesting its return.

28. A communication device mounted to a vehicle for use in a rental support system, comprising:
a transmitter for transmitting a request to an external communication device;
a receiver for receiving lending information and a return request from the external communication device; and
a display device for announcing the lending information and the return request.

29. A communication device mounted to a vehicle as an object for rent, comprising:
a receiver for receiving return information from a first communication device; and
a transmitter for transmitting an announcement including the return information,
wherein the first communication device transmits the return information to at least the third communication device, and
upon receiving the return information from the first communication device, the third communication device announces the information.
